(19) United States
(12) Patent Application Publication
(10) Pub. No.: US 2002/0055566 A1
(43) Pub. Date: May 9, 2002

(54) Water-based formulations with fungicidal action

(76) Inventors: Hans-Ulrich Buschhaus, Krefeld (DE); Peter Spetmann, Krefeld (DE); Thomas Jaetsch, Koln (DE); Martin Kugler, Leichlingen (DE)

Correspondence Address: Patent Department, Bayer Corporation, 100 Bayer Road, Pittsburgh, PA, 15205-9741, US

(21) Appl. No.: 09/552,044

(22) Filed: Apr. 19, 2000

(30) Foreign Application Priority Data
Apr. 24, 1999 (DE) 19918730.4

(51) Int. Cl. C08K 5/16

(52) U.S. Cl. 524/200; 524/203; 524/208

(57) ABSTRACT

The invention relates to storage-stable aqueous formulations containing at least one hydrolysis-sensitive active compound in combination with binders consisting of an alkyd resin based on vegetable oils and/or acrylate dispersions and having a pH≦7.

The present specification relates to storage-stable aqueous formulations which in addition to hydrolysis-sensitive active compounds comprise special binders for stabilizing the active compounds.

Their sensitivity to hydrolysis imposes conditions on the suitability of many broad-spectrum fungicides for use in water-based systems.

The mode of action of, for example, trihalogenomethylthio compounds such as dichlofluanid, tolylfluanid, fluorfolpet and folpet is based on the ability of the N—S bond to open in order subsequently to react nucleophilic groups (e.g. SH groups).

The half-life of the majority of these compounds in aqueous systems is a few minutes at alkaline pH levels (about pH 9), in the neutral range (about pH 7) a few hours, and in the acidic range (about pH 4) a few days.

Their use in water-based, so-called ready-to-use wood preservation varnishes and primers, emulsion paints and antifouling paints is therefore not an option owing to the short shelf life, which derives from the instability of the fungicides.

Surprisingly and totally unexpectedly it has now been found that active compounds sensitive to hydrolysis can be stabilized by using specific binder systems.

The specification therefore provides aqueous systems comprising at least one hydrolysis-sensitive active compound in combination with binders which consist of alkyd resins based on vegetable oils and/or acrylate dispersions and which in aqueous systems have a pH≦7.

Active compounds sensitive to hydrolysis are, in particular, fungicides, bactericides and insecticides which in acidic, neutral and especially alkaline systems have a half-life of a few minutes to six months.

Such active compounds are, in particular, compounds containing a functional group —N—S—CCl₂X, where X preferably represents fluorine, chlorine or CHCl₂.

Hydrolysis-sensitive active compounds for the purposes of the invention are, in particular, folpet, captan and captafol and, preferably, dichlofluanid, tolylfluanid and fluorfolpet.

Binders for the purposes of the invention are alkyd resins and acrylate dispersions, which may also, optionally, be present in copolymeric form and which have the characteristic that in aqueous solutions or emulsions they have a pH≦7, in particular ≦5, preferably ≦3.

Examples of preferred binders which may be mentioned are as follows:

alkyd/maleic anhydride copolymers, alkyd/modified linseed oil, alkyd resins, alkyd resin/soya oil/linseed oil in combination with acrylate dispersion.

Both the active compounds and the binders are known and are commercially available.

The aqueous systems of the invention, or ready-to-use compositions, contain preferably from 0.001 to 90, in particular from 0.01 to 50, more preferably from 0.1 to 5, with particular preference from 0.1 to 2 per cent by weight of active compound and preferably from 3 to 80, in particular from 5 to 50 and, more preferably, from 5 to 30 per cent by weight of binder.

Preferred examples of aqueous systems are water-based paints such as, in particular, emulsion paints and antifouling paints and also, preferably, wood preservatives such as, in particular, wood preservative varnishes and primers.

Aqueous systems optionally include constituents which are common for—in particular—wood preservative varnishes, emulsion paints and antifouling paints, such as pigments, dyes, auxiliaries, binders, emulsifiers, dispersants and further active compounds such as fungicides, insecticides and/or bactericides not sensitive to hydrolysis.

The aqueous systems of the invention have the advantage over the known systems that the active compounds are stable for long periods against hydrolysis and decomposition, both in an acidic and in a neutral medium.

The invention is elucidated further by the following examples. The invention is not restricted to the examples. In the text below, percentages are by weight.

### EXAMPLE

Tolylfluanid (TF) is incorporated into various water-based wood preservatives with stirring. The samples are tested for their storage stability at room temperature. The amount of active compound in the samples is measured by means of HPLC.

The table below reports the results:

TABLE 1

| | | | | % TF | | % TF, storage at RT | | | | |
|---|---|---|---|---|---|---|---|---|---|---|
| Ex.- | | Binder | pH of | | after | 1 | 2 | 3 | 9 | 12 |
| No | % | Description | B | theor. | prep. | mth. | mth. | mth. | mth. | mth. |
| 1 | 16.5 | Alkyd/soya/linseed oil + | 2 | 0.74 | 0.72 | 0.80 | 0.69 | 0.69 | 0.67 | 0.69 |
| | | acrylate dispersion | | | | | | | | |
| 2 | 16.5 | Alkyd | 3.5-5 | 0.74 | 0.74 | 0.97 | 0.75 | 0.64 | 0.63 | 0.62 |

1. Aqueous systems comprising at least one hydrolysis-sensitive active compound in combination with binders which consist of alkyd resin based on vegetable oils and/or acrylate dispersions and have a pH≦7.

2. Aqueous systems according to claim 1, in which the binders have a pH≦5.

3. Aqueous systems according to claim 1, in which the binders have a pH≦3.

4. Aqueous systems according to claim 1 which comprise as active compound compounds having a functional group N—S—CCl₂X, where X represents halogen or optionally halogen-substituted C₁-C₄-alkyl.

5. Aqueous systems according to claim 1, which comprise as active compounds folpet, captan, captafol, dichlofluanid, tolylfluanid and/or fluorfolpet.

6. Use of binders which consist of alkyd resin based on vegetable oils and/or acrylate dispersions and have a pH≦7 in water for stabilizing hydrolysis-sensitive active compounds in aqueous systems.

7. Use of binders which consist of alkyd resin based on vegetable oils and/or acrylate dispersions and have a pH≦7 in water in combination with hydrolysis-sensitive active compounds for protecting aqueous systems against microbial infestation.

8. Use according to one of claims 6 and 7, characterized in that the aqueous systems have a pH≦5.

9. Binders comprising alkyd resin based on vegetable oils and/or acrylate dispersions having a pH≦7 in water in combination with hydrolysis-sensitive active compounds.

10. Method of stabilizing hydrolysis-sensitive active compounds in aqueous systems, characterized in that the aqueous systems are admixed with binders consisting of alkyd resin based on vegetable oils and/or acrylate dispersions and having a pH≦7 in water.
